(19) United States
(12) Patent Application Publication
(10) Pub. No.: US 2016/0088266 A1
(43) Pub. Date: Mar. 24, 2016

(54) AUTOMATIC IMAGE COLOR CORRECITON USING AN EXTENDED IMAGER

(71) Applicant: THOMSON LICENSING, Issy de Moulineaux (FR)

(72) Inventors: Lin DU, Beijing (CN); Wei ZHOU, Beijing (CN); Gang CHENG, Beijing (CN)

(21) Appl. No.: 14/787,590

(22) PCT Filed: Jun. 28, 2013
(86) PCT No.: PCT/CN2013/078361

§ 371 Date: Oct. 28, 2015

(51) Int. Cl. H04N 9/04; G06T 7/40; H04N 1/60; H04N 9/73

(52) U.S. Cl. CPC H04N 9/045; H04N 9/735; G06T 7/408; H04N 1/6044

(57) ABSTRACT

A method and apparatus for performing automatic color correction are described. In one embodiment, the apparatus is an image capture apparatus including a lens, an extended imager for capturing an image frame including a scene and a color calibration chart, and a digital image processing unit configured to perform color correction on the captured scene using the captured color calibration chart. The extended imager includes an output area for capturing the scene and an extended area for capturing the color calibration chart at substantially the same time while keeping the respective images of the scene and the chart spatially separate.

### FIELD OF INVENTION

The present invention relates to the fields of photography and video recording, and more particularly, to a method and apparatus for automatic color correction of digital photographs and digital video.

### BACKGROUND

Modern cameras or camcorders make great pictures or video with the advanced optical devices and electronic imagers, such as a charge-coupled device (i.e., “CCD”) or Complementary Metal-Oxide-Semiconductor (i.e., “CMOS”) imagers. However, the color of the actual image being captured usually has some noticeable mismatch with the reproduced ones after recording. Such a mismatch is typically due to many factors, such as the imperfection of color representation on display, the translation from camera color gamut to display color gamut, the color bias caused by different lighting temperature, and exposure condition.

Current solutions to this problem include taking or capturing a picture of a precise color calibration chart before shooting each scene. This allows the photographer to create a consistent reference of the real color and a representation of that color. Color calibration charts provide precise information about how camera hue adjustments are affecting the full gamut of color reproduction. Image quality and consistency can be enhanced by recording chart information to tape or film, and using it in post-processing as a baseline production reference. For scene-to-scene or multiple cameras consistency, the photographers or filmmakers can record a few chart frames with every lighting change, then process the color correction, matching footage, and digital/special effects needed in the post-processing period.

However, the above calibration method takes considerable human effort to implement. Furthermore, it is still not as precise or consistent as requiring both a perfectly calibrated monitor and a skilled professional able to clearly recognize slight imperfections in color. In situations when the lighting of a scene keeps changing, it becomes impractical to shoot the color calibration chart for each and every lighting change.

### SUMMARY

The problems in the prior art are overcome by an image capture device configured or performing automatic color correction of a captured image. In one embodiment, the image capture device includes a lens and an extended imager for producing a captured image of a scene and a color calibration chart, the extended imager configured for capturing the scene to an output area and the color calibration chart to an extended area at substantially the same time. The scene and the color calibration chart are spatially separate from each other.

Another embodiment provides a method of automatic color correction for a captured image frame, the method includes: capturing an image frame including a scene and a color calibration chart, the color calibration chart including a plurality of colors. A color correction table is created based on the plurality of colors in the color calibration chart and a plurality of predefined reference colors; and the color correction table is applied to the scene of the captured image frame.

### BRIEF DESCRIPTION OF THE DRAWINGS

For a more complete understanding of the present principles, reference is made to the following detailed description of an embodiment considered in conjunction with the accompanying drawing, in which:

FIG. 1 is a diagram of a view from the lens of an image capture device constructed in accordance with an embodiment of the present principles;

FIG. 2 is a schematic diagram illustrating the components of the image capture device shown in FIG. 2; and

FIG. 3 is a flow chart illustrating a method of automatic color correction in accordance with an embodiment of the present principles.

### DETAILED DESCRIPTION OF THE INVENTION

Embodiments of the present principles generally relate to a method and apparatus for automatically correcting the colors of a captured image based on standard references, such as a color calibration chart and a right white balance. The apparatus includes a lens, an extended imager that has a first area for capturing a scene, and a second area for capturing a color calibration chart that is not a part of the scene, and positioned separately from the scene. The color calibration chart provides known color values for use as reference colors in color correction. The purpose of the extended imager is to contemporaneously capture a color calibration chart with each picture taken to allow for automatic color correction, while keeping the color calibration chart spatially separate from the scene to be captured. In other words, the color calibration chart is able to be used for color correction while being “hidden” from a captured view of the scene.

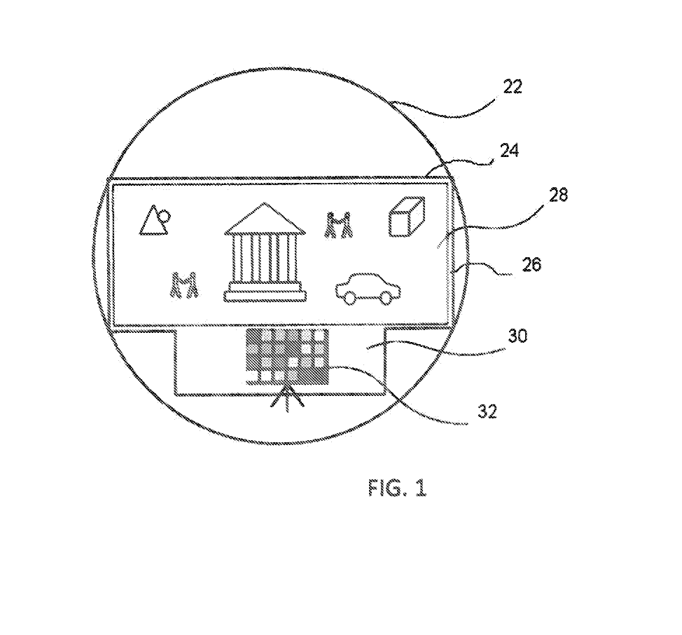

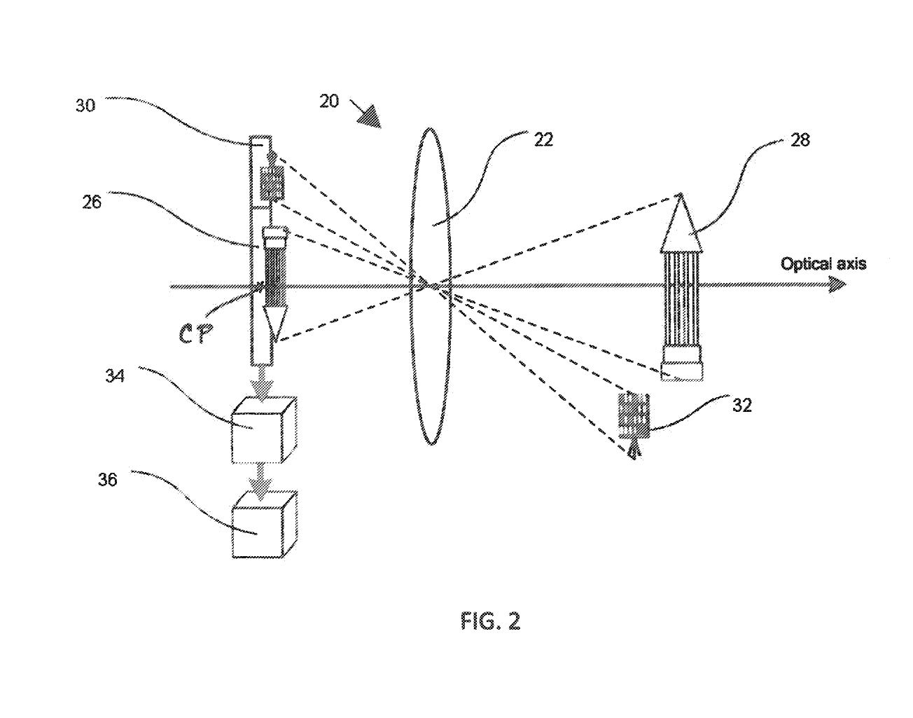

FIGS. 1 and 2 illustrate various features of an image capture device 20, such as a camera or camcorder, constructed in accordance with an embodiment of the present invention. The primary components of the image capture device 20 are standard components found in many digital cameras well known in the art. Such components include a shutter, flash, memory, processor, and image display, except as discussed below. Some of these standard components are not shown in FIGS. 1-2. As shown in FIG. 2, the image capture device 20 includes a lens 22 and an extended imager 24 for capturing a digital image of the scene to be photographed.

The extended imager 24 includes an output area 26 that is centered with respect to the lens 22 about the lens' optical axis, i.e., the optical axis is perpendicular to the surface of the output area 26, and intersects the output area at its center point CP. The output area 26 is sized and shaped to capture a scene 28 for a photograph or frame that is proportioned for a standard size or common format for a photograph or image frame. The extended imager 24 also includes an extended area 30 located adjacent to the output area 26. The extended area 30 is not intended to capture a portion of the scene 28 that is to appear in the resulting photograph or image frame. Rather, the extended area 30 is sized and shaped to capture a color calibration chart 32 (positioned outside of the scene 28, as shown in FIG. 2) as part of each image capture of the scene 28.

The image capture device 20 is configured so that each image capture (controlled by the camera shutter) results in the scenes image being captured to the output area 26 at the same time as the image of the color calibration chart being captured to the extended area 30. This is further illustrated in FIG. 1, which shows the relative positions of the scene 28 and color calibration chart 32, e.g., as viewed through the lens 22. FIG. 1 also shows that the scene 28 is imaged onto the output area 26 of the extended images 24, and the color calibration chart 32 is imaged onto the extended area 30, without any overlap between the images of the chart and the scene.

The color calibration chart 32 includes a plurality of colors that are separated into blocks, with each block representing a color that is substantially the same as, or similar to, a color found in the scene 28 as chosen by the photographer or movie-maker These color blocks serve as reference points, i.e., predetermined reference color values, for the image capture device 20 to use when performing color correction of the captured scene 28. The captured image of the color calibration chart 32 does not appear in the output area 26, thereby maintaining a separation between the captured images of color calibration chart 32 and the scene 28. This enables the captured image of the color calibration chart 32 to be isolated from any resulting image of the scene 28 output by the image capture device. By contemporaneously capturing the color calibration chart 32 with the scene 28, the image capture device 20 allows the color calibration chart 32 and the scene 28 to be captured under substantially the same lighting conditions (since the chart is positioned close to the scene). The image capture device 20 can also automatically perform precise color correction on each frame of the scene 28, as further discussed below.

The image capture device 20 also includes a digital image processing unit (DIPU) 34. The DIPU 34 is configured to detect the captured image of the color calibration chart 32 in each picture or image frame and build a color translation (or color correction) table for the entire image in the picture or frame according to its known reference colors and the color blocks found in the color calibration chart 32. The DIPU 34 is then able to correct the colors in the captured scene automatically, select the image of the captured scene in the output area 26 so as to eliminate the color calibration chart 32 from view, and output only the color-corrected image from the picture frame. The image capture device 20 also includes a storage unit 36 for storing each color-corrected image from the output area 26 produced by the DIPU 34.

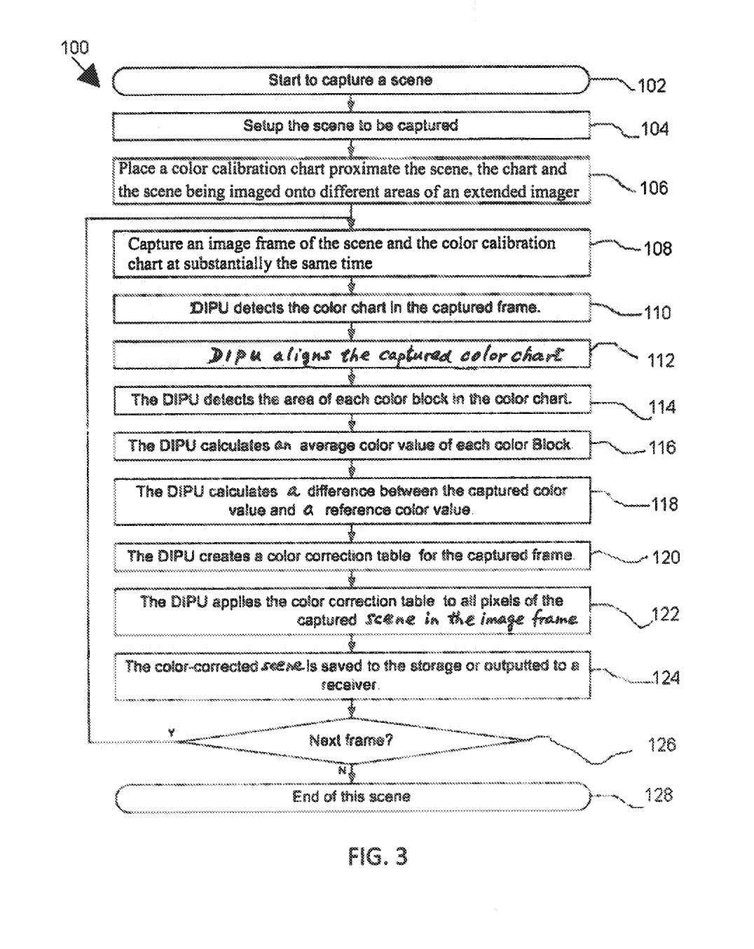

FIG. 3 illustrates a method 100 of automatic color correction in accordance with an embodiment of the present invention. In the embodiment shown in FIG. 3, the method 100 is performed using the image capture device 20 discussed above. It should also be appreciated that other embodiments of the method 100 can use other image capture devices having a lens and an imager capable of capturing a color calibration chart in conjunction with a scene while keeping the captured image of the color calibration chart separate from the output area of the imager.

The method 100 begins the capture of a scene (step 102) with a scene 28 being set up to be captured on the imager (step 104), e.g., by a photographer or movie-maker Once the scene 28 has been set up, a color calibration chart 32 is placed adjacent to, or proximate the scene 28 such that the color calibration chart 32 will only be imaged and captured in the extended area 30 of the extended imager 24 (step 106), but not in the output area 26. Depending on the specific configuration of the extended imager 24, for example, the relative positions of the extended area 30 and output area 26, the calibration chart 32 can be placed below or above the scene 28. In whatever manner the color calibration chart 32 is oriented, it is placed such that the extended imager 24 can view the color calibration chart 32 with sufficient resolution to distinctly define the different colors represented in the color correction chart 32, without the image of the chart extending past the confines of the extended area 30 in order to avoid obscuring the scene in the output area 26.

Once the scene 28 has been set up to be imaged or captured in the output area 26 and the color calibration chart 32 has been oriented to be imaged or captured in the extended area 30, the image capture device 20 captures an image frame of the scene 28 and color calibration chart 32 (step 108). Thereafter, the DIPU 34 of the image capture device 20 begins to analyze the raw image from the imager 24. The DIPU 34 begins by detecting the color calibration chart 32 in the captured frame (step 110). This can be done automatically using a conventional pattern recognition method used by digital cameras.

Upon detecting the chart, the DIPU 34 aligns the captured color correction chart for further processing (step 112), and then detects the area of each color block (step 114), which can occur through the use of a predefined chart pattern. The DIPU 34 then calculates an average color value of each color block in the color calibration chart 32 (step 116). The DIPU 34 also calculates a difference between the average color value of each captured color block and the corresponding reference color value known from the color calibration chart (step 118).

A color correction table is then created by the DIPU 34 based on results of these calculations, i.e., difference between the color value of each block in the captured image of the chart and the corresponding expected color value (predetermined reference color for that block) for the captured image frame (step 120). The DIPU 34 then uses the color correction table to apply color correction to each pixel of the captured image of the scene (step 122). In one embodiment, the DIPU 34 creates the color correction table by using the color difference values found in step 118 as sample points for color correction and distributes these sample points throughout the color gamut. The DIPU 34 then color corrects each pixel in the captured scene by using the interpolated color correction values from the sample points close to the pixel in question. Doing so results in a color-corrected scene that may be reproduced for a photograph or a motion picture.

Once color correction has been performed by the DIPU 34, the color-corrected scene in the image frame is selected and saved to the storage unit 36 (step 124), without saving the color calibration chart. The color-corrected scene can be selected using software in the DIPU, e.g., by cropping the scene image in the output area 26, while excluding the color chart in the extended area 30 of the imager 24. Alternatively, the color-corrected scene in the image frame can be outputted to an external receiver for storage elsewhere or for reproduction. Thereafter, the photographer or movie-maker determines whether any additional frames of the scene 28 should be captured (step 126). This decision can take place merely by the photographer or movie-maker continuing to shoot the scene 28 as he or she sees fit. If more shots of the scene 28 must be captured, the method 100 returns to step 108 for capturing the next frame and for performing the color correction process as discussed above. Alternatively, the photographer or movie-maker can continue to shoot the scene 28 while the DIPU is still engaging in color correction of a previously-captured image frame. When color correction of a previous frame is completed, the DIPU 34 can check if additional frames have been taken and if so, the DIPU 34 can execute the color correction process again starting at step 110. If, however, it is decided that no more shots of the scene 28 are to be taken, the photographer ceases shooting the scene 28 (step 128) and may move on to other scenes or cease shooting altogether.

Another embodiment provides a method for color correction using the image capture apparatus of the present principles. The method includes capturing an image frame that includes a scene and a color calibration chart, the color calibration chart including a plurality of colors. A color correction table is created based on the plurality of colors in the color calibration chart and a plurality of predefined reference color values. The color correction table is used for applying color corrections to the scene in the captured image frame.

The various embodiments disclosed herein can be implemented as hardware, firmware, software, or any combination thereof. Moreover, the software is preferably implemented as an application program tangibly embodied on a program storage unit or computer readable medium, which, when executed by a processor, causes a method described above to be implemented. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It will be understood that the embodiments described herein are merely exemplary and that a person skilled in the art may make many variations and modifications without departing from the spirit and scope of the invention. All such variations and modifications are intended to be included within the scope of the invention as defined in the appended claims.

1. An image capture apparatus for performing automatic color correction, comprising:
a lens and an extended imager for producing a captured image of a scene and a color calibration chart, the extended imager configured for capturing the scene to an output area and the color calibration chart to an extended area at substantially the same time; wherein the scene and the color calibration chart are spatially separate.

2. The image capture apparatus according to claim 1, wherein the extended area is adjacent to the output area, and wherein the extended area and the output area do not overlap.

3. The image capture apparatus according to claim 1, further comprising a digital image processing unit configured to perform color correction on the captured scene using the captured color calibration chart to produce a color-corrected image frame.

4. The image capture apparatus according to claim 3, wherein the digital image processing unit is configured to:
detect the color calibration chart from the captured image frame, the color calibration chart having a plurality of colors therein;
create a color correction table based on the plurality of colors in the color calibration chart and a plurality of predetermined reference colors; and
apply the color correction table to the scene of the captured image frame.

5. The image capture apparatus according to claim 4, wherein the digital image processing unit is further configured to:
calculate an average color value for each color of the plurality of colors in the color calibration chart;
calculate differences between each average color value from the color calibration chart and a corresponding reference color from the plurality of predetermined reference colors, and
use the differences as sample points in creating the color correction table.

6. The image capture apparatus according to claim 4, further comprising cropping the scene from the captured image frame to produce the color-corrected image frame.

7. The image capture apparatus according to claim 3, further comprising a storage unit configured to store the color-corrected image frame.

8. A method of automatic color correction for a captured image frame using an image capture apparatus, the method comprising:
capturing an image frame including a scene and a color calibration chart, the color calibration chart including a plurality of colors;
creating a color correction table based on the plurality of colors in the color calibration chart and a plurality of predefined reference colors; and
applying the color correction table to the scene of the captured image frame.

9. The method according to claim 8, wherein creating a color correction table includes:
calculating an average color value for each color of the plurality of colors in the color calibration chart;
calculating differences between each average color value in the color calibration chart and a corresponding reference color from a plurality of predetermined reference colors; and
using the differences as sample points to create the color correction table.

10. The method according to claim 8, wherein the scene and the color calibration chart in the captured image frame are spatially separate and do not overlap.

11. The method according to claim 10, further comprising, after applying the color correction table to the scene of the captured image frame, cropping the scene from the captured image frame to produce a color-corrected scene image, and saving the color corrected scene image to a memory.

12. The method according to claim 8, wherein the scene and the color calibration chart are captured at substantially the same time by operating a shutter of the image capture apparatus.

13. The method according to claim 12, wherein the color calibration chart and the scene are captured at a lighting condition that is substantially the same for the color calibration chart and the scene.
